(19) United States
(12) Patent Application Publication
(10) Pub. No.: US 2010/0296275 A1
(43) Pub. Date: Nov. 25, 2010

(54) LAMP ASSEMBLY INCLUDING A LAMP DEVICE DETACHABLE FROM A STAND UNIT FOR SERVING AS A TORCH LIGHT

(75) Inventor: Wen-Hsiang Chien, Taipei Hsien (TW)

Correspondence Address: ROSENBERG, KLEIN & LEE, 3458 ELLICOTT CENTER DRIVE-SUITE 101, ELLICOTT CITY, MD, 21043, US

(73) Assignee: ADVANCED-CONNECTEK INC., TAIPEI (TW)

(21) Appl. No.: 12/604,676

(22) Filed: Oct. 23, 2009

(30) Foreign Application Priority Data
May 22, 2009 (TW) 098117009

(51) Int. Cl. F21L 4/00

(52) U.S. Cl. 362/183; 315/362; 362/192

(57) ABSTRACT

A lamp assembly includes a lamp device mounted detachably on a stand unit. The lamp device includes a lampshade for receiving a light emitting element. An electrical connector is coupled electrically to the light emitting element and a power source in such a manner that when the lamp device is mounted on the stand unit, the electrical connector is plugged into the power source so that the light emitting element is supplied with electricity by the power source. A storage battery module is coupled electrically to the electrical connector and the light emitting element so that when the lamp device is mounted on the stand unit, the storage battery module is charged by the power source via the electrical connector. When the lamp device is detached from the stand unit, the light emitting element is supplied with electricity by the storage battery module.

This application claims the benefits of the Taiwan Patent Application Serial No. 098117009, filed on May 22, 2009, the subject matter of which is incorporated herein by reference.

### BACKGROUND OF THE INVENTION

1. Field of the Invention

The present invention relates to a lamp assembly, more particularly to a lamp assembly including a stand unit and a lamp device mounted detachably on the stand unit. The lamp device is detachable from the stand unit and is adapted to be served a torch light.

2. Description of the Prior Art

A lamp assembly plays an important role in our daily life. For instance, desktop lamp or table lamp we usually used at home or office generally provides light rays in order to illuminate the drawing room so as to turn the environment into high standard of living.

Most of the aforesaid lamps or lamp assemblies generally rely on A/C power since the latter is easily available at homes and offices and is the cheapest in cost presently. However, in case of breakdown of electricity, the lamps or lamp assemblies are rendered useless.

In the past, in order to counter the electrical breakdown, an emergency lamp or a torch light is usually kept to avoid total darkness of the environment. The torch light or emergency light usually uses storage battery, which produces direct current. The torch light or emergency lamp is kept ready for specific occasions, such as power breakdown, occupies some storage space, and sometimes cannot be easily located in a hurry. Often, even if one can lay hands on the torch light, the torch light may not work since the storage battery may be ruined due to humidity in the atmosphere or due to expiry. The battery itself becomes weak if it is kept unused for a long period of time.

Therefore, it is the object of the present invention to provide a lamp assembly having a lamp device detachable from a stand unit for serving as a torch light when circumstance requires, thereby eliminating the problems encountered during use of the prior art lamp assembly.

### SUMMARY OF THE INVENTION

One aspect of the present invention is to provide a lamp assembly having a stand unit and a lamp device that provides lighting in the normal condition. When the lamp device is detached from the stand unit in time of power breakdown and can be used as a torch light so that the user needs not replace the battery of the torch light during the normal condition.

Another aspect of the present invention to provide a lamp assembly, where a set of LEDs (Light Emitting Element) is formed as an LED module for serving as a lamp device, thereby lowering the cost of manufacturing material and providing aesthetic appearance of the product.

Still another aspect of the present invention is to provide a lamp assembly including an adjustable lamp stand, its position relative to a bottom seat is variable. An On/Off switch device in the lamp assembly is designed ergonomically to facilitate manipulation of the user. The lamp assembly further includes a switch device for controlling switch-on or switch-off operation of the LED module so that in time of power breakdown or when the lamp device is detached from the stand unit, activation of the switch device can result in switch-on or switch-off operation of the LED module.

The lamp assembly of the present invention accordingly includes a stand unit and a lamp device for detachably mounting on the stand unit such that the lamp assembly serves as table lamp, desktop lamp or bedside lamp. In case of power breakdown, the lamp device can be detached from the stand unit for serving as a torch light. The torch light is provided with a switch device for manual and automatic operation thereof.

The stand unit employed in the lamp assembly of the present invention includes a power source. The lamp device further includes a light emitting element, a lampshade, an electrical connector and a storage battery module.

The light emitting element is capable of emitting light rays upon switch on. The lampshade includes an integral lampshade body formed with an opening to emit the light rays from the light emitting element to an exterior of the lampshade body.

The electrical connector is disposed at one side of the lampshade, is coupled electrically to the light emitting element, and is coupled detachably with the power source. When the lamp device is mounted detachably on the stand unit, the electrical connector is plugged into the power source so that the light emitting element is supply with electricity by the power source via the electrical connector.

The storage battery module is coupled electrically to the electrical connector and the light emitting element so that when the lamp device is mounted detachably on the stand unit, the storage battery module is charged by the power source via the electrical connector and when the lamp device is detached from the stand unit, the light emitting element is supplied with electricity by the storage battery module.

The stand unit further includes a bottom seat and a lamp stand having a lower end fixed to the bottom seat and an upper end holding the power source.

The lamp stand is fixed to the bottom seat via a rotary structure. The rotary structure includes a lower connecting part and an upper connecting part.

The lower connecting part is fixed on the bottom seat and defines a receiving chamber therein. The upper connecting part is connected securely to the lower end of the lamp stand, and has an enlarged rotary disc disposed rotatably within the receiving chamber in the lower connecting part.

Under this condition, rotation of the rotary disc in the receiving chamber simultaneously results in changing position of the lamp stand relative to the bottom seat.

In addition, the stand unit further includes an On/Off switch mounted on an external surface of the bottom seat for controlling switch-on or switch-off operation of the light emitting element. In one embodiment, the On/Off switch is sandwiched between the lower end of the lamp stand and the upper connecting part so as to be exposed to an exterior of the bottom seat. Preferably, a light detection switch can be used for the On/Off switch so that variation in the light of the environment can activate the switch to control switch-on and switch-off operation of the light emitting element.

The lamp device further includes a switch device mounted on an external surface of the lampshade body and coupled electrically to the light emitting element.

Therefore, the lamp assembly of the present invention is used as table or desktop lamp. In case the lamp device is detached from the stand unit, the same can serve as a torch light or emergency lamp. Due to the storage battery module, no reserved battery is needed or replacement of battery is required. The lamp device does not require specific room for storage in the normal time. In time of power breakdown, the lamp device can be easily located due to its daily use, thereby facilitating the user, which, in turn, saving the expense for buying a conventional torch light for emergency application.

Due to presence of the rotary structure, the position of the lamp stand with respect to the bottom seat can be adjusted. The On/Off switch is designed ergonomically to facilitate manipulation of the user. The switch device on the lampshade body enables the user to control switch-on or switch-off operation of the light emitting element, when the lamp device is detached from the stand unit.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a lamp assembly of the present invention in use;

FIG. 2 is a perspective view of the lamp assembly of the present invention, illustrating a lamp device is detached from a stand unit for independently serving as a torch light;

FIG. 3 is an exploded view of the lamp device employed in the lamp assembly of the present invention;

FIG. 4 is an exploded view of the stand unit employed in the lamp assembly of the present invention;

FIG. 5A is a perspective view of a rotary structure in the stand unit employed in the lamp assembly of the present invention;

FIG. 5B is an exploded view of the rotary structure in the stand unit employed in the lamp assembly of the present invention;

FIG. 5C shows a partly exploded view of a bottom seat of the stand unit employed in the lamp assembly of the present invention;

FIG. 6 shows fragmentary exploded view of some components employed in the lamp assembly of the present invention; and

FIG. 7 a perspective view of a modified lamp assembly of the present invention when not in use.

### DETAILED DESCRIPTION OF THE PREFERRED EMBODIMENTS

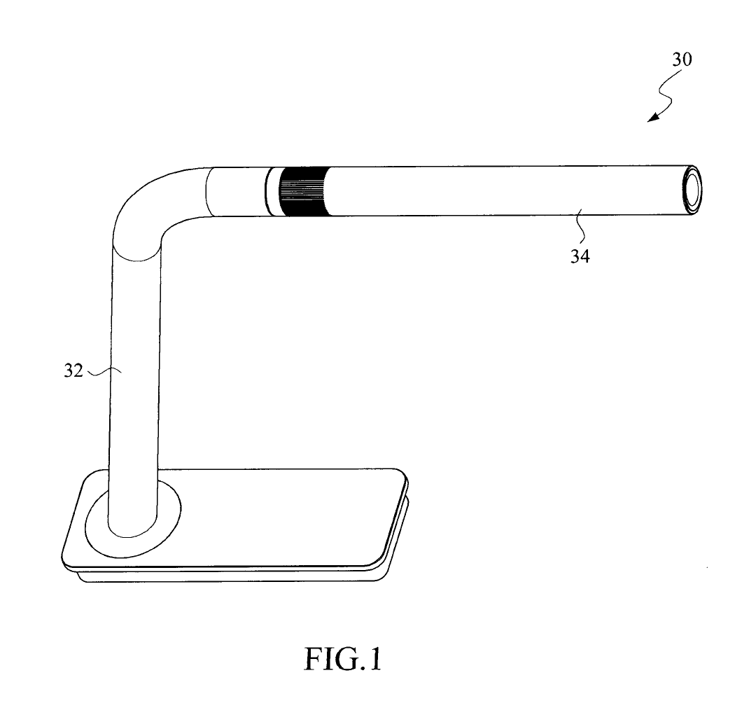

FIG. 1 is a perspective view of a lamp assembly 30 of the present invention, and includes a stand unit 32 and a lamp device 34. The lamp device 34 is mounted detachably on the stand unit 32. The lamp assembly 30 can be a table lamp or a stand-alone lamp, like the one we dispose at bedside.

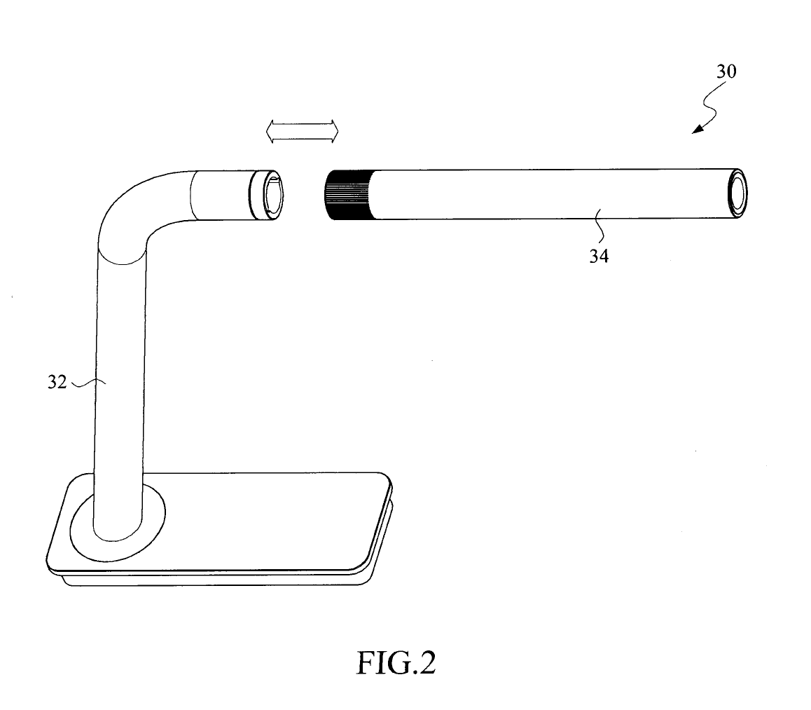

FIG. 2 is a perspective view of the lamp assembly 30 of the present invention, illustrating the lamp device 34 is detached from the stand unit 32 for independently serving as a torch light or emergency lamp in time of breakout of electricity.

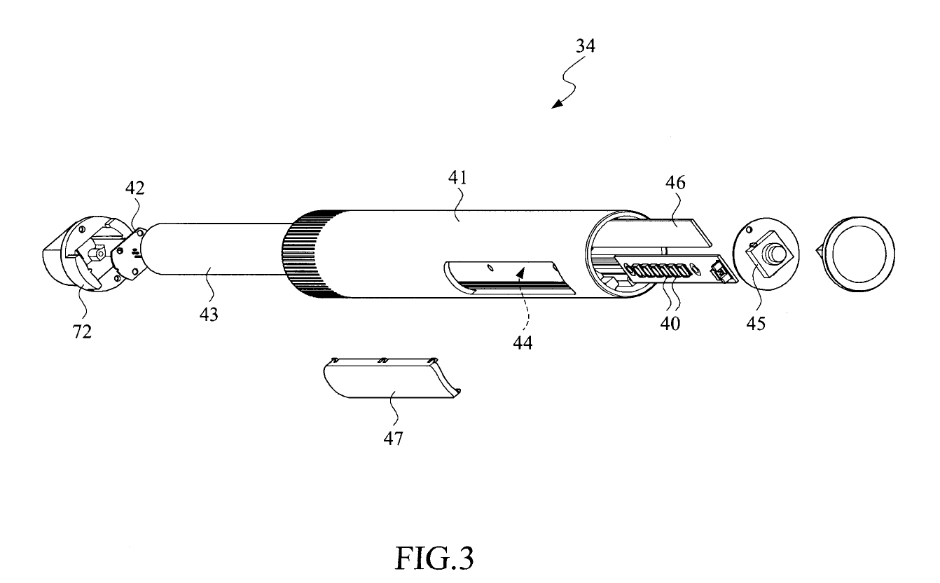

FIG. 3 is an exploded view of the lamp device employed in the lamp assembly 30 of the present invention. As illustrated, the lamp device 34 includes a light emitting element 40, a lampshade 41, an electrical connector 42 and a storage battery module 43.

In the present invention, a set of LEDs (Light Emitting Diode) or incandescent bulbs may serve as the light emitting element 40 for emitting light rays. As illustrated, the lampshade 41 includes a lampshade body, in which the set of LED module 40 is disposed in such a manner that the light rays of the LED module are emitted to an exterior of the lampshade 41 via an opening 44 formed in the lampshade body. An aluminum sheet is preferred to for fabricating the lampshade 41 due to its light reflection ability and its lightness in weight. The lampshade body may have a tubular configuration for aesthetic beauty, but the design or structure should not be limited thereto.

A high efficient terminal set or high efficient connector is chosen for serving as the electrical connector 42. The electrical connector 42 is disposed at one side (near the stand unit) of the lampshade body 41 for coupling electrically to the LED module 40 via a first coupler 70 of the stand unit 32. The lamp device 34 further includes a second coupler 72 complementing with and for coupling to the first coupler 70 in order to connect the lamp device 34 detachably to the stand unit 32. Under this condition, the electrical connector 42 is plugged into the power source 50 of the stand unit 32 so that the LED module 40 is supplied with the power source, i.e., A/C current.

Any storage battery unit, such as lithium battery, may serve as the storage battery module 43. The storage battery module 43 is disposed in the lampshade body 41, is coupled electrically to the electrical connector 42 and the LED module 40 so that when the lamp device 34 is mounted detachably on the stand unit 32, the storage battery module 43 is charged by the power source 50 via the electrical connector 42 and when the lamp device 34 is detached from the stand unit 32, the LED module 40 is supplied with electricity by the storage battery module 43. Under this condition, the lamp device 34 serves as a torch light.

In another embodiment, an electrical coupler, such as a USB (Universal Serial Bus) device serves as the electrical connector 42 such that the lamp assembly of the present invention can be coupled to an electronic assembly (such as computer set) via the USB device so that the LED module 40 is supplied with electricity by the computer set or the storage battery module 43 is charged by the computer set. In addition, the electrical connector 42 can be coupled electrically to an adaptor that is plugged into a powered socket of an automobile. Under this condition, the electrical connector 42 is supplied with electricity by power source of the automobile. The electrical connector 42 can be coupled to a generator driven by wind power, such as by installing the device to a bicycle pedal assembly such that the pedaling action creates the wind power. Then, the electrical connector 42 is supplied with electricity by the generator driven by wind power. Alternately, the electrical connector 42 can be coupled to a generator driven by solar power. Under this condition, the electrical connector 42 is supplied with electricity by the generator driven by solar power.

To facilitate operation of the lamp device 34 as the torch light, a switch device 45 is mounted on an external surface (preferably at one side) of the lampshade body 41 and is coupled electrically to the LED module 40. Alternately, the switch device 45 can be mounted either on the top or bottom part of the lampshade body.

The lamp device 34 further includes a control panel 46 fixed within the lampshade body 41 and is electrically connected to the switch device 45 such that when the power source 50 is disconnected electrically or when the lamp device 34 is detached from the stand unit 32 so as to disengage the electrical connector 42 from the power source 50, the control panel 46 activates the switch device 45 to control switch-on or switch-off operation of the LED module 40. In other words, the lamp device 34 has its own switch device 45 when serving as the torch light or emergency lamp.

In addition, in one embodiment of the present invention, the control panel 46 can be arranged in such a manner that once the lamp device 34 is detached from the stand unit 32, the control panel 46 directly activates switch-on or switch-off operation of the LED module 40.

Preferably, a transparent lid 47 is attached to the lampshade body 41 for shielding the opening 44, thereby preventing undesired dust from entering into an interior of the lampshade body 41. The transparent lid 47 in one way provides another aesthetic beauty to the lamp device 34.

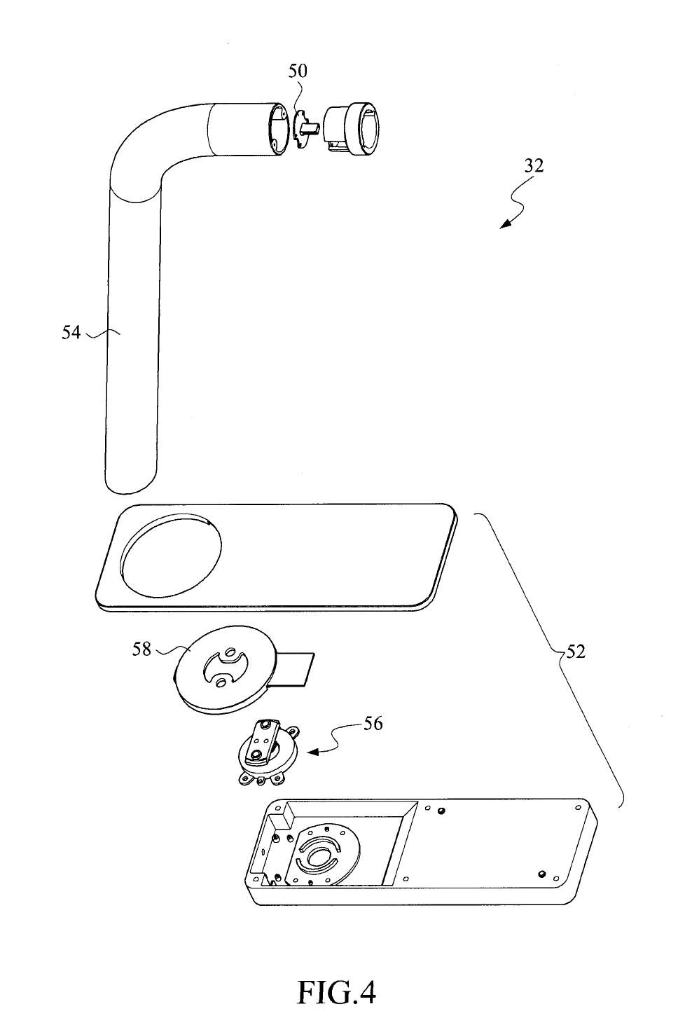

FIG. 4 is an exploded view of the stand unit 32 employed in the lamp assembly of the present invention. The power source 50 of the stand unit 32 is coupled electrically to the A/C power via the wiring cables or electrical connector.

Generally speaking, a set of terminals can serve as the power source 50 and is connected to the A/C power via the electrical connector 42 so as to supply A/C power to the LED module 40 and the storage battery module 43. The stand unit 32 further includes a bottom seat 52 and a lamp stand 54 having a lower end fixed to the bottom seat 52 via a rotary structure 56 and an upper end holding the power source 50.

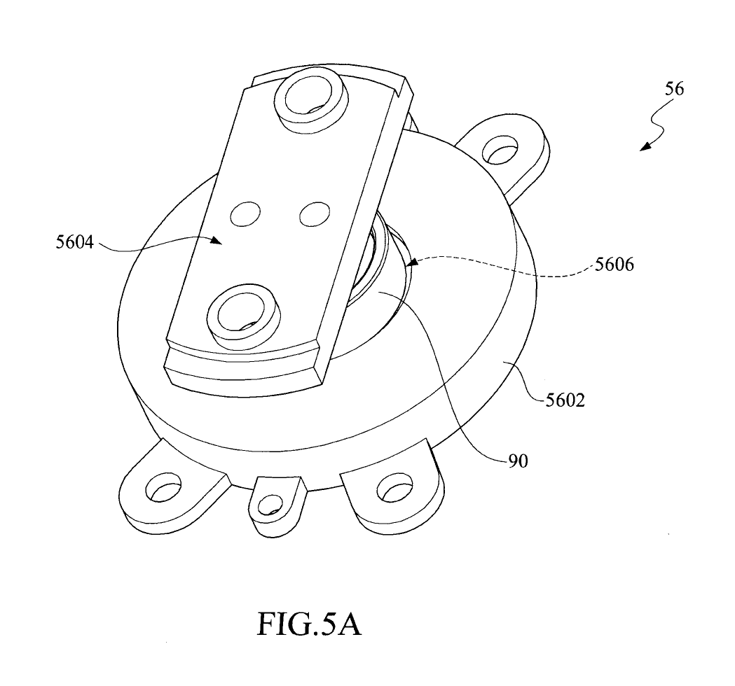

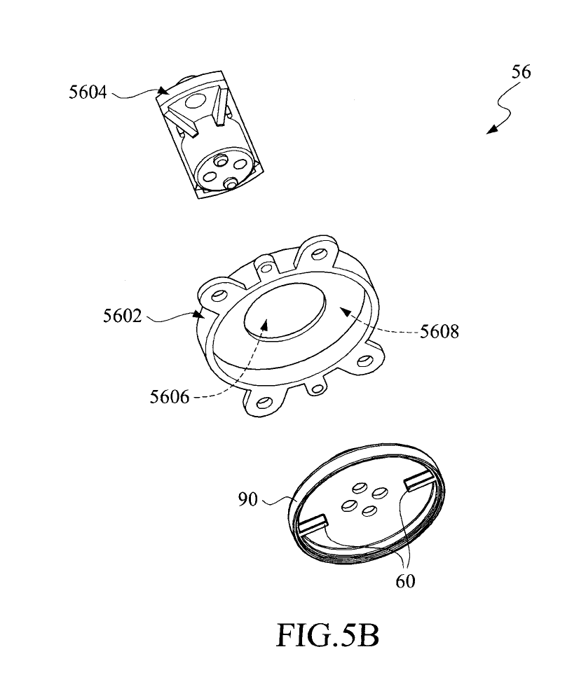

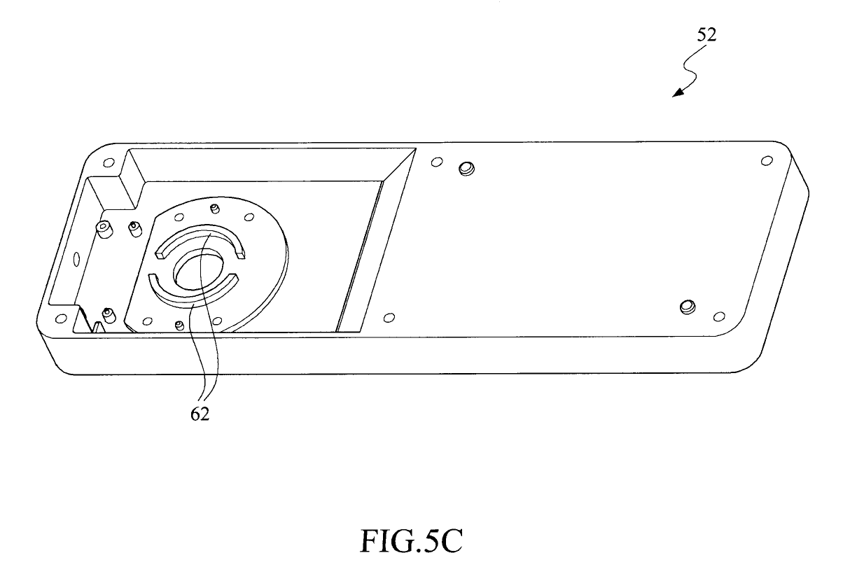

Referring to FIGS. 4, 5A, 5B and 5C, wherein FIG. 5A is a perspective view of the rotary structure 56 in the stand unit employed in the lamp assembly of the present invention, FIG. 5B is an exploded view of the rotary structure 56 while FIG. 5C shows a partly exploded view of the bottom seat of the stand unit employed in the lamp assembly of the present invention. The rotary structure 56 includes a lower connecting part 5602 and an upper connecting part 5604.

For lasting and rigidity purposes, the lower and upper connecting parts 5602, 5604 are made from metal. The lower connecting part 5602 is fixed on the bottom seat 52 and defines a receiving chamber 5608 therein.

The upper connecting part 5604 is connected securely to the lower end of the lamp stand 54, and has an enlarged rotary disc 90 disposed rotatably within the receiving chamber 5608 in the lower connecting part 5602 such that the upper connecting part 5604 is exposed to an exterior of the lower connecting part 5602 via an opening 5606. To facilitate mounting purposes, the upper connecting part 5604 is formed as two-piece structure.

At this time, rotation of the rotary disc 90 in the receiving chamber 5608 simultaneously results in changing position of the lamp stand 54 relative to the bottom seat 52.

Referring to FIGS. 5B and 5C, the rotary disc 90 is formed with a first pair of interfering elements 60 adjacent to an outer surface of the bottom seat 52. The bottom seat 52 has a second pair of interfering elements 62 adjacent to an external surface of the rotary disc 90 such that rotation of the rotary disc 90 within the receiving chamber 5608 results in inter-engagement between the first and second interfering elements 60, 62, thereby securely retaining the lamp stand 54 at a predetermined angle with respect to the bottom seat 52.

Referring again to FIG. 4, the lamp assembly 30 further includes an On/Off switch 58 for controlling switch-on or switch-off operation of the LED module 40. In the present embodiment, the On/Off switch 58 is sandwiched between the lower end of the lamp stand 54 and the upper connecting part 5604, and is exposed to an exterior of the bottom seat 52 to facilitate manipulation thereof. The On/Off switch 58 can be a light detection switch such that the On/Off switch 58 will be activated depending on the changing light beams in the environment. Some conventional switch devices can also be used instead of the light detection switch 58.

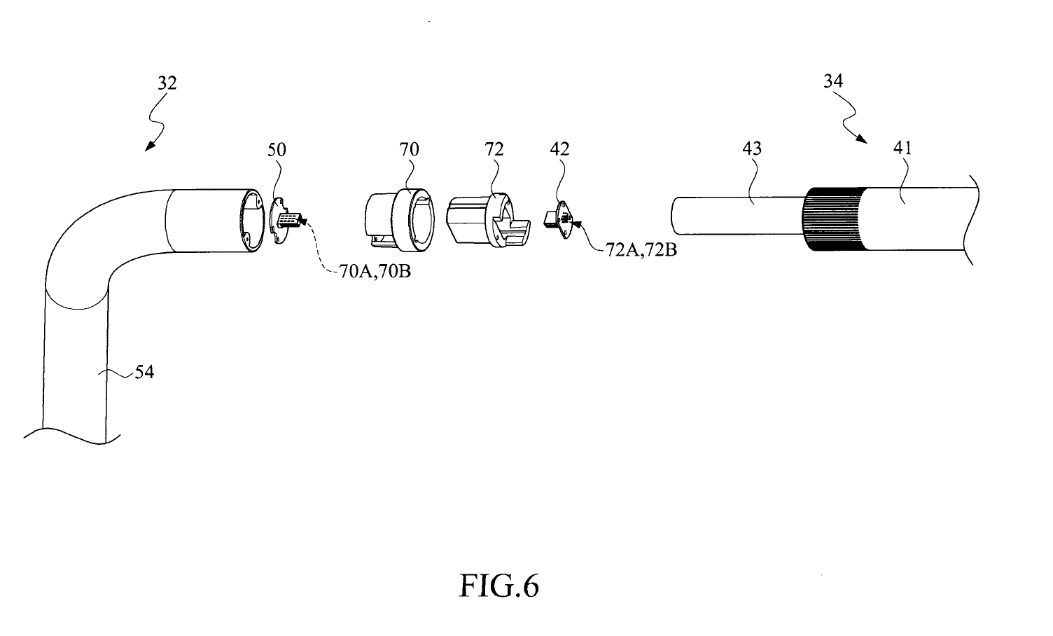

FIG. 6 shows fragmentary exploded view of the power source 50 and the electrical connector 42 employed in the lamp assembly 30 of the present invention. As illustrated, the first coupler 70 is disposed at the upper end of the lamp stand 54. The second coupler 72 is disposed at one side of the lampshade body 41 and complements with for coupling to the first coupler 70 in order to connect the lamp device 34 detachably to the lamp stand 54.

To be more specific, the power source 50 includes a first charging connector 70A and a first supply connector 70B. The electrical connector 42 includes a second charging connector 72A coupled electrically to the storage battery unit 43 and a second supply connector 72B coupled electrically to the LED module 40 so that when the lamp device 34 is mounted on the stand unit 32, the first and second charging connectors 70A, 72A are connected electrically to each other while the first and second supply connectors 70B, 72B are connected electrically to each other. Under this condition, the LED module 40 and the storage battery module 43 in the lamp device 34 are supplied with the A/C power.

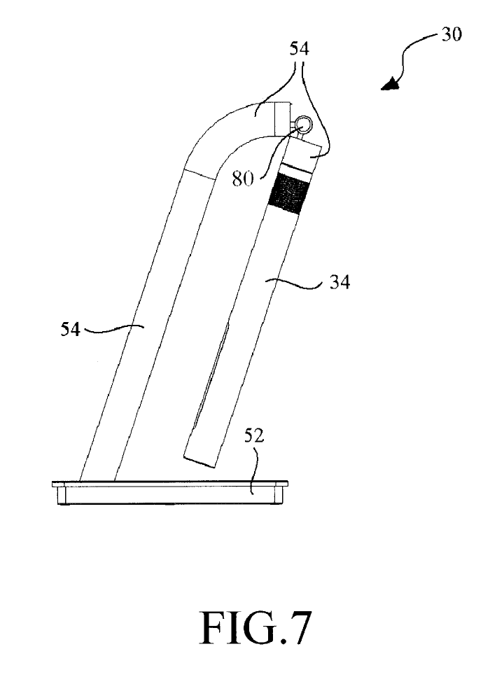

FIG. 7 a perspective view of a modified lamp assembly 30 of the present invention having the structure similar to the previous embodiment. The only difference resides in that the lamp stand 54 includes two stand sections and a pivot member 80 in the form of shaft interposed between the stand sections so as to permit folding action of the lamp device 34 relative to the bottom seat 52, thereby minimizing the storage space of the lamp assembly 30 to facilitate storage and for carrying along with the user.

Therefore, the lamp assembly 30 of the present invention includes the lamp device 34 mounted detachably on the stand unit 32 and provides light in the normal condition. When circumstances demand, the lamp device 34 can be detached from the stand unit 32 for serving as the torch light or emergency lamp. Due to presence of the chargeable storage battery module 43, the latter is not required to be replaced with new ones in the normal condition. No special storage room is required for keeping the lamp device 34 and the latter can be easily detached from the stand unit for serving as the torch light in time of power breakdown or when it is desired.

The lampshade body 41 is a one-piece member serving the lamp device 34. Installation of the rotary structure 56 between the stand unit 32 and the bottom seat 52, the position of the lamp stand 54 with respect to the bottom seat 52 can be easily adjusted to facilitate the user.

In addition, the lamp assembly 30 of the present invention is ergonomically designed, for instance, the switch device 45 can be manipulated for switch-on and switch-off operation of the LED module 40 after detaching the lamp device 34 from the stand unit 32. When using the lamp assembly 30 as table lamp or desktop lamp, the light detection switch 58 can be implemented for controlling switch-on or switch-off operation of the LED module 40.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lamp device for mounting detachably on a stand unit and for coupling electrically to a power source of the stand unit, comprising:
a light emitting element for emitting light rays;
a lampshade for receiving said light emitting element therein, and formed with an opening via which said light rays of said light emitting element are emitted to an exterior of said lampshade;
an electrical connector disposed at one side of said lampshade for coupling electrically to said light emitting element and the power source in such a manner that when the lamp device is mounted detachably on the stand unit, said electrical connector is plugged into the power source so that said light emitting element is supplied with electricity by the power source; and
a storage battery module for coupling electrically to said electrical connector and said light emitting element so that when the lamp device is mounted detachably on the stand unit, said storage battery module is charged by the power source via said electrical connector and when the lamp device is detached from the stand unit, said light emitting element is supplied with electricity by said storage battery module.

2. The lamp device according to claim 1, wherein the lamp device and the stand unit cooperatively form a lamp assembly, the stand unit further including a bottom seat and a lamp stand having a lower end fixed to said bottom seat and an upper end holding the power source.

3. The lamp device according to claim 1, further comprising a switch device mounted on an external surface of said lampshade and coupled electrically to said light emitting element, a control panel fixed within said lampshade and electrically connected to said switch device such that when the power source is disconnected electrically or when the lamp device is detached from the stand unit so as to disengage said electrical connector from the power source, said control panel activating said switch device to control switch-on or switch-off operation of said light emitting element.

4. The lamp device according to claim 3, wherein the power source includes a first charging connector and a first supply connector, said electrical connector including a second charging connector coupled electrically to said storage battery module and a second supply connector coupled electrically to said light emitting element so that when the lamp device is mounted on the stand unit, said first and second charging connectors are connected electrically to each other while said first and second supply connectors are connected electrically to each other.

5. A lamp assembly comprising:
a stand unit for holding a power source thereon;
a lamp device for mounting detachably on said stand unit and including
a light emitting element for emitting light rays,
a lampshade for receiving said light emitting element therein, and formed with an opening via which said light rays of said light emitting element are emitted to an exterior of said lampshade,
an electrical connector disposed at one side of said lampshade for coupling electrically to said light emitting element and the power source in such a manner that when said lamp device is mounted detachably on the stand unit, said electrical connector is plugged into the power source so that said light emitting element is supplied with electricity by the power source, and
a storage battery module for coupling electrically to said electrical connector and said light emitting element so that when said lamp device is mounted detachably on said stand unit, said storage battery module is charged by the power source via said electrical connector and when said lamp device is detached from said stand unit, said light emitting element is supplied with electricity by said storage battery module.

6. The lamp assembly according to claim 5, wherein said stand unit further includes a bottom seat and a lamp stand having a lower end fixed to said bottom seat and an upper end holding the power source.

7. The lamp device assembly according to claim 6, wherein said lamp stand is fixed to said bottom seat via a rotary structure, said rotary structure including a lower connecting part fixed on said bottom seat and defining a receiving chamber therein and an upper connecting part connected securely to said lower end of said lamp stand and having a rotary disc disposed rotatably in said receiving chamber, wherein rotation of said rotary disc in said receiving chamber simultaneously results in changing position of said lamp stand relative to said bottom seat.

8. The lamp assembly according to claim 7, wherein said rotary disc is formed with a first interfering element adjacent to an outer surface of said bottom seat, said bottom seat having a second interfering element adjacent to an external surface of said rotary disc such that rotation of said rotary disc in said receiving chamber results in inter-engagement between said first and second interfering elements, thereby retaining said lamp stand at a predetermined angle with respect to said bottom seat.

9. The lamp assembly according to claim 7, further comprising an On/Off switch for controlling switch-on or switch-off operation of said light emitting element.

10. The lamp assembly according to claim 9, wherein said On/Off switch is sandwiched between said lower end of said lamp stand and said upper connecting part and is exposed to an exterior of said bottom seat.

11. The lamp assembly according to claim 9, wherein said On/Off switch is a light detection switch.

12. The lamp assembly according to claim 5, further comprising a switch device mounted on an external surface of said lampshade and coupled electrically to said light emitting element, a control panel fixed within said lampshade and electrically connected to said switch device such that when the power source is disconnected electrically or when said lamp device is detached from the stand unit so as to disengage said electrical connector from the power source, said control panel activating said switch device to control switch-on or switch-off operation of said light emitting element.

13. The lamp assembly according to claim 5, wherein the power source includes a first charging connector and a first supply connector, said electrical connector including a second charging connector coupled electrically to said storage battery module and a second supply connector coupled electrically to said light emitting element so that when said lamp device is mounted on the stand unit, said first and second charging connectors are connected electrically to each other while said first and second supply connectors are connected electrically to each other.

14. The lamp assembly according to claim 6, wherein said stand unit further includes a first coupler attached to said upper end of said lamp stand, said lamp device further including a second coupler complementing with and for coupling to said coupler in order to connect said lamp device detachably to said stand unit.

15. The lamp assembly according to claim 6, wherein said lamp stand includes two stand sections, said lamp assembly further comprising a pivot member interposed between said stands sections so as to permit folding action therebetween.

16. The lamp assembly according to claim 5, wherein an electrical coupler serves as said electrical connector such that when the lamp assembly is coupled electrically to an electronic assembly via said electrical coupler, said light emitting element is supply with electricity by the electronic assembly and said storage battery module is charged by the electronic assembly.

17. The lamp assembly according to claim 5, wherein when said electrical connector is coupled electrically to an adaptor that is plugged into a powered socket of an automobile, said electrical connector is supplied with electricity by power source of the automobile.

18. The lamp assembly according to claim 5, wherein when said electrical connector is coupled to a generator driven by wind power, said electrical connector is supplied with electricity by the generator driven by wind power.

19. The lamp assembly according to claim 5, wherein when said electrical connector is coupled to a generator driven by solar power, said electrical connector is supplied with electricity by the generator driven by solar power.
